(19) United States
(12) Patent Application Publication
(10) Pub. No.: US 2003/0171957 A1
(43) Pub. Date: Sep. 11, 2003

(54) Process for inspecting and certifying roofs for structures and repairing leaking roofs during the certification period

(76) Inventor: Leslie P. Watrous, Orange, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/094,874

(22) Filed: Mar. 11, 2002

(51) Int. Cl. G06F 17/60; G01B 3/52; G06F 19/00; G01B 3/44

(52) U.S. Cl. 705/4

(57) ABSTRACT

A process for inspecting and certifying roofs for structures and either repairing the leaking roof during the certification period, assisting the structure owner to file an insurance claim for the repair, and/or providing repair estimates and contractor contact information. The inspection and certification process is a multistep operation which is intended to bring consistency and uniformity in the manner in which roofs are inspected and certified.

### BACKGROUND OF THE INVENTION

The present invention relates to roof inspections and repairs. More particularly, the present invention relates to a process for certifying roofs for structures and repairing leaking roofs during the certification period.

It may not be obvious to an owner of a house or structure whether his or her roof has any damage, and even if the owner is aware that the roof is damaged, the owner may not appreciate the full extent of the damage. The roof damage may be very small at first, such as when shingles are blown from the roof in a windstorm. However, over time such small damage can allow water and the elements to work their way into the roof and even the house or other structure supporting the roof. If the roof is not periodically repaired, it may eventually have to be entirely replaced. Even worse, water leakage may cause structural damage not just to the roof, but also to the house or structure supporting the roof. It is evident then, that over time, relatively small roof damage can escalate into a serious and expensive problem for the owner of the house or structure.

Even if the owner of the house or structure is aware that the roof is damaged and needs to be repaired or replaced, the owner is left with the daunting task of finding a reputable and honest contractor who will fix the roof. Even after having an inspection and an appraisal, the owner may be left wondering whether the appraisal and cost estimate of the job is accurate or not. The owner of the structure may even request several inspections and appraisals resulting in different analyses and cost estimates. This may be due to several factors, including the thoroughness of the inspection.

The owner of the structure may not be aware that an insurance policy covering the structure will pay for the repair to the roof under certain circumstances. Even if the homeowner is aware of such insurance coverage, the owner may not know whether the damage to the roof is covered under the insurance policy or whether the damage occurred by normal wear and tear or other uninsured causes.

Accordingly, there is a need for uniformity in the inspection process. The is also a need for a roof certification process which helps the owner of the structure determine the cause and extent of damage to his or her roof and the repairs necessary to fix the roof and assistance with the preparing and filing of insurance claims of the damage as covered. Such a certification process should allow the owner to purchase certification if the roof is in good order and to receive periodic inspections and repairs as necessary during the certification time period. The present invention fulfills these needs and provides other related advantages.

### SUMMARY OF THE INVENTION

The present invention resides in a process for inspecting, certifying and repairing roofs in a consistent manner. The present invention is intended to provide uniformity and consistency in the manner in which roofs are inspected to assess the condition and necessary repairs of the roof, and provide a roof certification warranty over a predetermined time period.

The invention includes inspecting the interior of a building for signs of roof leakage. The condition of the exterior of the building and the roof are also inspected for obvious signs of leakage, wear and tear due to age, and missing or damaged roof components. If the roof leaks, a repair estimate is provided and the necessary repairs indicated for rendering a roof certification.

If the roof does not leak, it is determined whether the roof in its current condition has a likelihood of leaking during the certification time period. It is also determined that if the roof leaks during the certification period, the roof is in sufficient condition to be repaired and that such repairs can last until the end of the certification period. If it is determined that the roof has a likelihood of leaking during the certification, or that the roof is in insufficient condition to be repaired during the certification period, a repair estimate is prepared and the necessary repairs are completed upon approval of the building owner.

If it is determined that the roof will likely not leak during the certification period and the roof is in sufficient condition to be repaired during the certification period, if it does leak, a certification is granted. Similarly, a certification is granted for the predetermined time period if the roof has been adequately repaired to meet these conditions.

During the certification period, if the roof leaks, the interior of the building is inspected to verify the existence of the leak. The cause of the roof leak is determined, and it is determined whether the building owner has applicable insurance that would cover the cause of the roof leak.

If the owner of the building does not have insurance, or it is determined that the cause of the leak is due to normal wear and tear not covered by insurance, the roof leak is repaired at no cost to the building owner. A cost estimate is prepared for emergency services, interior restoration and roof repair necessitated by the roof leak and not covered by insurance. These services and repairs are performed upon authorization of the building owner.

If it is determined that the building owner has applicable insurance and that the cause of the roof leak is at least partially covered by the applicable insurance, the building owner is notified and asked if he or she would like assistance preparing and filing a claim against the applicable insurance on behalf of the building owner, or if the building owner desires to pay for the selected repair services instead. If the building owner does not approve of the filing of a claim against the applicable insurance, and does not agree to pay for the selected repair services, the certification is voided. However, an insurance claim is prepared and filed on behalf of the building owner for payment of losses covered by insurance upon request of the owner. The insurance claim may be assigned to the certification repair contractor, who then performs authorized and selected repair services. As insurance policies often require mitigation of damages, any necessary emergency services, interior restoration and roof repairs caused by the roof leak and covered by the insurance or authorized by the building owner are performed.

In the event that the cause of the roof leak and damage is by a third party or other cause not covered by insurance, it is first determined whether a claim is to be filed against the third party. When a claim is not to be filed against a third party, a cost estimate is prepared for emergency services, interior restoration and roof repair resulting from the third party damage. These services and repairs are performed when the building owner agrees to pay for the repairs and services. Otherwise, a claim is prepared and filed for losses against the third party. The claim may be assigned to the roof certificaton contractor. It is determined if there is roof or interior damage resulting from third party for the non-covered cause, and any authorized emergency services, interior restoration and roof repairs resulting from the third party damage is performed. If the building owner does not approve of the filing of a claim against the third party and is unwilling to pay for the repair services, the certification is voided.

As will be appreciated by the reader, the process of the present invention creates uniformity in the inspection and certification process. Also, the process of the present invention aids a certified building owner in determining the cause of the roof leak, the extent of any damage, and assists with claims to be filed against insurance policies or third parties. The uniformity and consistency of the present invention allows the invention to be incorporated into an inspection, certification, and repair business operating across a region or even nationwide with consistent results and expectations.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a flow chart illustrating the inspection process and the determination of whether a certification is issued;

FIG. 2 is a flow chart illustrating the steps taken during certification when the owner of the structure does not have insurance coverage;

FIG. 3 is a flow chart illustrating the steps taken during certification when an inspection is conducted and the owner of the structure has insurance coverage and the roof failure is caused by an Act of God, or other covered damage;

FIG. 4 is a flow chart illustrating the steps taken during inspection when the owner of the structure has insurance coverage and the roof failure is caused by a third party damage or other non-covered causes;

FIG. 5 is a flow chart illustrating the steps taken during an inspection when an owner of the structure has insurance coverage and the roof failure is caused by normal wear and tear; and

FIG. 6 is a flow chart illustrating the steps taken when the roof failure is determined to be caused by a combination of failures.

### DETAILED DESCRIPTION OF THE PREFERRED EMBODIMENT

As shown in the drawings for purposes of illustration, the present invention is concerned with a process for inspecting and certifying roofs for structures and either repairing the leaking roof during the certification period, assisting the structure owner and filing an insurance claim for the repair, and/or providing repair estimates and contractor contact information. The inspection and certification process is a multistep operation which is intended to bring consistency and uniformity in the manner in which roofs are inspected and certified. Although roof inspections are typically conducted by certified inspectors, without such a process each inspector may perform inspections of varying degrees of thoroughness and certify the roof based upon their own subjective evaluations instead of pre-defined parameters.

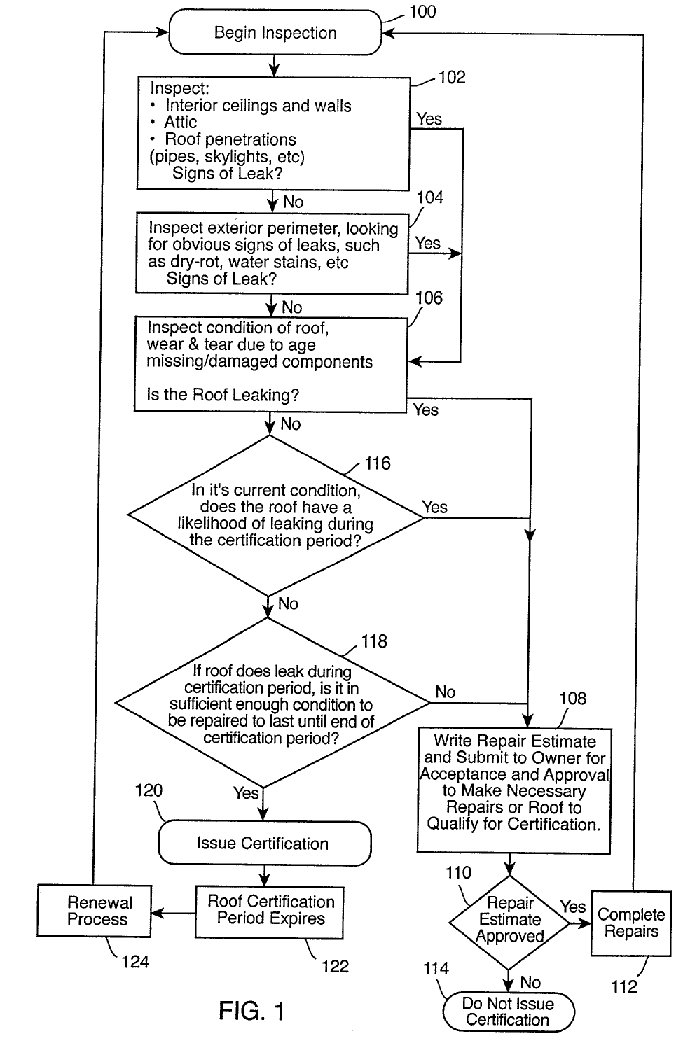

FIG. 1 illustrates the steps taken in the initial inspection and certification of the building. The certification and inspection process begins 100 by inspecting interior of the building, including ceilings and walls, attic and roof penetrations, such as pipes, chimney, skylights, etc. 102. If there are signs of leakage, the roof itself is inspected 106. However, if there are no signs of leakage, the exterior perimeter of the building is inspected, particularly the roof eaves, examining for obvious signs of water leakage, such as dry rot, water stains, mold, etc. 104. If no signs of leakage are present, the condition of the roof itself is inspected to determine its condition. Wear and tear due to age are assessed and any missing, damaged or worn out components are identified 106. If it is determined that the roof is leaking, a repair estimate is written and submitted to the owner for acceptance and approval to make the necessary repairs for the roof to qualify for certification 108. If the repair estimate is approved 110, the repairs are completed 112 and the inspection process results in certifiable roof. However, if the repair estimate is not approved, no certification is issued 114.

If the roof is not leaking, a determination is made as to the likelihood of the occurrence of any leakage problem during the projected certification period 116. If so, a repair estimate is written and submitted to the owner to make the necessary repairs for the roof to qualify for certification 108. If it is determined that the roof does not have a likelihood of leaking during the certification period, it is next determined whether the roof is in sufficient condition to be repaired to last until the end of the certification period in the event that the roof does leak 118. If not, a repair estimate is written and submitted to the owner to make the necessary repairs 108. If the building and roof do not show signs of leakage 102-106, is not likely to leak during the certification period 1 16 and is in sufficient condition to be repaired if necessary 118 (or if repairs are completed to place the building in such condition 112) a certification is issued 120 on the roof of the building for a predetermined time period. Once the roof certification period expires 122 the building owner is contacted and asked whether the certification is to be renewed 124, at which point the certification process described above is repeated.

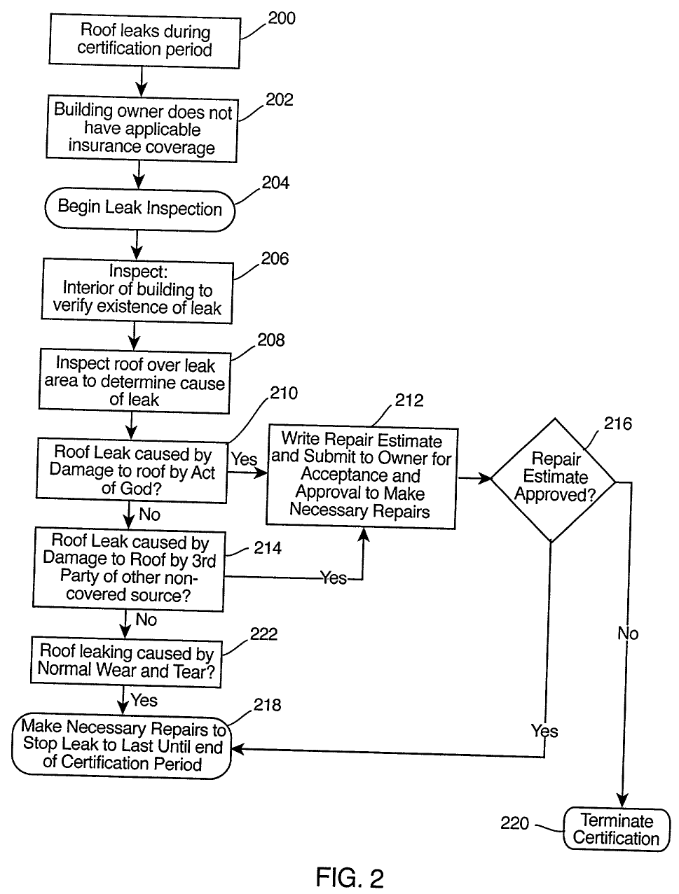

FIGS. 2-6 illustrate the steps taken upon notification by the building owner of roof leakage during the certification period. It is first determined whether the building owner has applicable insurance coverage. FIG. 2 illustrates the steps taken during the process if the roof leaks during the certification process 200 and the building owner does not have applicable insurance coverage 202.

The leak inspection is begun 204 by inspecting the interior of building to verify the existence and source of the leak 206. Next, the roof is inspected to determine the area and cause of the leak 208. If it is determined that the leak is caused by an Act of God, such as a thunderstorm, tornado, etc. 21 0, a repair estimate is written and submitted to the owner for acceptance and approval to make the necessary repairs 212. Similarly, if the cause of the roof leak is determined to be due to damage caused by third parties, or any other cause other than normal wear and tear 214, the repair estimate is written and submitted to the owner 212. If the repair estimate is approved 216, the necessary repairs are made to stop the leak to last until the end of the certification period 218. If the repair estimate is not approved, the certification is terminated 220 as the roof is no longer in condition to pass the certification process. If the roof leak is not caused by an Act of God, or other third party damage 210 and 214, but rather caused by normal wear and tear 222, the contractor issuing the certification makes the necessary repairs to stop the leak until the end of the certification period 218 at no cost to the building owner.

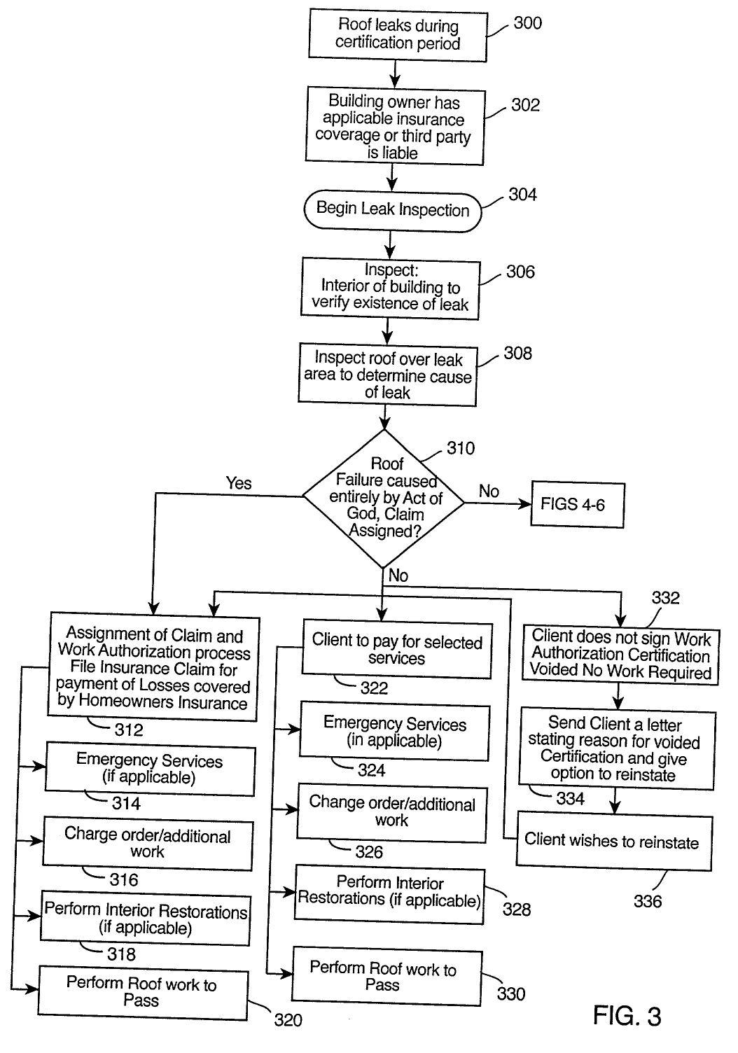

With reference to FIG. 3, if the roof leaks during the certification period 300 and the building owner has applicable insurance coverage, or a third party is liable 302, a leak inspection is conducted 304. As described above, the interior of the building is inspected to verify the existence and location of the leak 306, and the roof over the leak area is inspected to determine the cause of the leak 308.

If the roof failure and cause of the leak is determined to be caused entirely by an Act of God, or other insurance covered cause 310, it is determined whether the claim is to be filed with the insurance company and whether the claim will be assigned to the roof contractor. If so, an assignment of claim and work authorization insurance claim is created and filed for payment of losses covered by the applicable insurance, often homeowners insurance 312. Providing the assistance in preparing such an insurance claim can be of great value to the building owner as the building owner may be inexperienced in filing such insurance claims. Also, the certifying roof contractor will submit a detailed claim of all damage and restoration that needs to be repaired. Thus, the building owner need not rely exclusively upon a roof inspector from the insurance company who may not provide as detailed an inspection. As insurance policies often require mitigation of damages, any emergency services 314, such as tarping the roof to prevent further damage, etc. are performed if applicable. The building owner may request that the roof contractor perform more than just the emergency services, and a change order will be produced for the additional work to be performed 316. Also, any interior restorations that are necessary either under the insurance policy or at the request of the building owner are performed 318. Finally, the roof is repaired to the extent that it will pass the certification process 320.

It is anticipated that there may be circumstances in which the homeowner's insurance does not completely cover the extent of the damage, or the client desires to pay for the selective services instead of submitting an insurance claim 322. In this event, the emergency services 324 additional exterior work 326 and interior restorations 328 are performed as requested by the building owner and to the extent necessary for the roof to pass the certification process 330.

However, if the building owner does not sign the work authorization to be filed with the insurance company, and does not agree to pay for selected services, the certification is voided and no work is performed 332. The roof contractor subsequently sends a letter to the building owner stating the reason for the voided certification, namely, that the roof is no longer in condition for certification, and gives an option to reinstate 334. If the client wishes to reinstate 336, he or she either signs the assignment of claim and work authorization 312 or agrees to pay for the selected services 322.

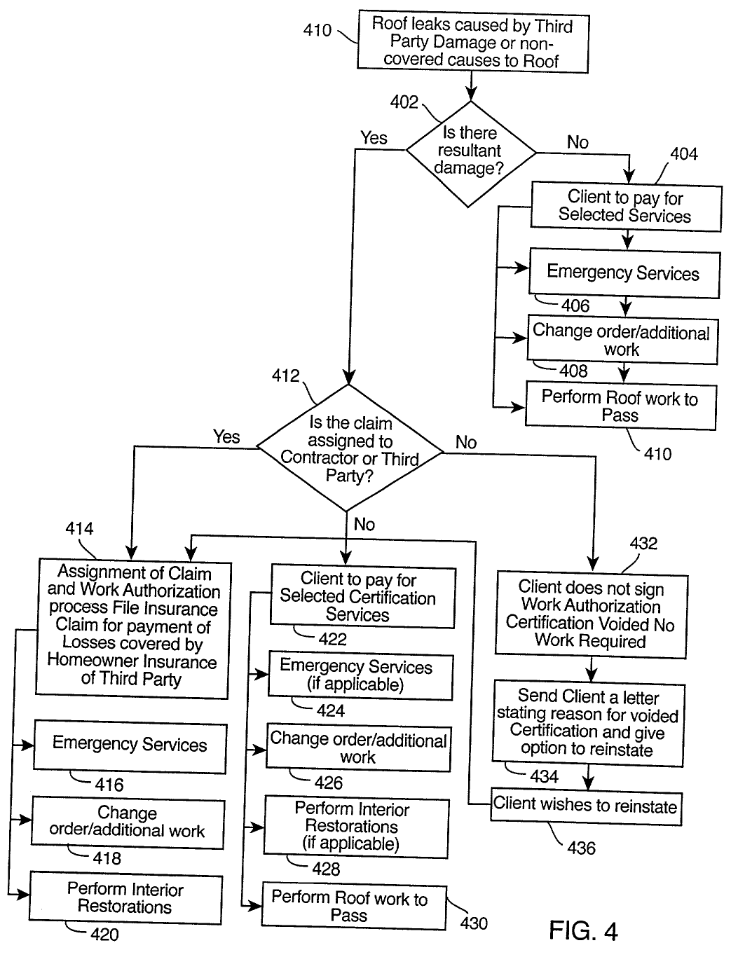

In the event that the roof leak is determined to be caused by non-covered insurance causes, such as third party damage 400, the steps illustrated in FIG.4 are taken. Anticipated third parties that might cause such damage include neighborhood children playing upon the roof, electricians or other contractors who perform other services but in the process damaged the roof, etc. It is first determined whether there is any resultant damage from the roof failure. If not, a repair estimate is created and presented to the client for payment of selected services 404, which may include emergency services 406, additional work 408, including interior restoration, and the roof is repaired adequately to pass the certification process 410.

However, if there is resultant damage 402 it is next determined whether the claim is to be assigned to the contractor or submitted to the third party 412 which caused the damage. If so, an assignment of claim and work authorization document is processed and filed with the third party, or applicable insurance carrier, for payment of losses covered by the insurance 414. Emergency services 416, additional work 418 and necessary interior restorations are performed as necessary. The roof contractor may decide to file a claim against the homeowner's insurance policy informing them of the cause of the damage, at which point the owner's insurance might pay for the loss and subrogate against the third party or third parties' insurance carrier.

In the event that payment for the losses are not covered by the homeowner's insurance, or cannot be obtained from the third party or third party insurance carrier, the building owner must agree to pay for the selected certification services 422. Such would include applicable emergency services 424, any requested additional work to be performed by the building owner 426, interior restorations 428, etc. In either case, the roof is repaired to the extent necessary that it would pass the certification process 430. If the client does not sign the work authorization claim nor agree to pay for the selected services, the certification is voided and no work is performed 432. Once again, a letter is sent to the building owner stating the reason for the voided certification and the building owner is given the option to reinstate the certification 434. If the building owner wishes to reinstate 436, he or she must sign off on the insurance claim, assign the claim to the contractor, or agree to pay for the services 414 and 422.

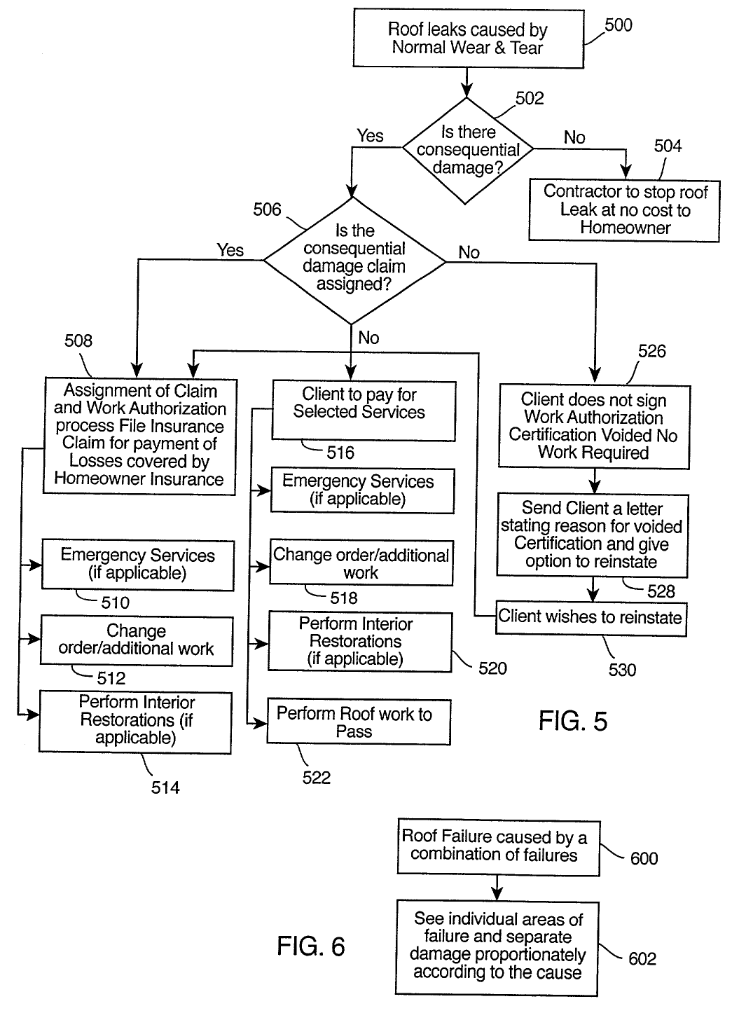

With reference to FIG. 5, roof leaks which are caused by normal wear and tear 500 are inspected to determine if there is any consequential damage 502, that is any resulting damage other than damage to the roof. If not, the certifying roof contractor stops the roof leak at no cost to the homeowner 504. However, if there is consequential damage, it is determined whether the building owner's insurance will cover such consequential damage 506. If so, a work authorization and insurance claim document is prepared and filed with the applicable insurance for payment of losses covered 508. Necessary emergency services 510, additional work 512 and interior restorations 514 are performed as described above. If the consequential damage is not covered by insurance, or the building owner does not wish to file an insurance claim, but agrees to pay for the selective services 516, the necessary emergency services 518, additional work 520, interior restorations 522, etc. are performed and the roof is repaired adequately to pass the certification process, or not leak during the remainder of the certification time period 524. If the building owner does not sign the work authorization and does not agree to pay for the selective services, the certification is voided and no work is performed 526. A letter is sent to the client stating the reason for the voided certification and given an option to reinstate 528. If the client wishes to reinstate 530 the client either agrees to pay for the selective services 516 or file an appropriate insurance claim, which may be assigned to the roofing contractor 508.

If during the course of the inspection it is determined that the roof failure is caused by a combination of failures 600, for example, a thunderstorm damages the roof and an electrician repairing electrical problems caused by the thunderstorm causes further damage, both the third party electrician and the homeowner's insurance may be required to pay for the losses. In such instances, the individual areas of failure described and illustrated above are followed and the damage is separated proportionally according to the cause 602.

The invention is to be performed by roofing contractors using a set of documents and check lists, etc. as necessary to perform the above-described process. In a particularly preferred embodiment of the invention, the process is implemented using a computer system so that the necessary reports and documentation can be saved and easily accessed or printed on demand. Such a computer process also assists both the owner and the certifier in producing insurance claim reports and repair history of the building structure.

Although several embodiments of the present invention have been described in detail for purposes of illustration, various modifications of each may be made without departing from the spirit and scope of the invention. Accordingly, the invention is not to be limited, except as by the appended claims.

What is claimed is:

1. A process for inspecting, certifying and repairing roofs in a consistent manner, comprising the steps of:
inspecting the interior of a building for signs of roof leakage;
inspecting the condition of the exterior of the building and roof for obvious signs of leakage, wear and tear due to age, and missing or damaged roof components;
if the roof leaks, preparing a repair estimate and completing approved repairs;
if the roof does not leak, determining whether the roof in its current condition has a likelihood of leaking during a predetermined certification period, and determining if the roof leaks during the certification period that the roof is in sufficient condition to be repaired during the certification period;
if it is determined that the roof has a likelihood of leaking during the certification period, or that roof is in insufficient condition to be repaired during the certification period, preparing a repair estimate and completing approved repairs; and
granting certification for the predetermined period if the roof has been adequately repaired so that it is not leaking, will not likely leak during the certification period and is repairable during the certification period, or it is determined that the roof will likely not leak during certification period and roof is in sufficient condition to be repaired until end of certification period if roof leaks during the certification period.

2. The process of claim 1, including the step of inspecting the interior of the building to verify the existence of a leak if roof leaks during the certification period.

3. The process of claim 2, including the step of determining the cause of the roof leak.

4. The process of claim 3, including the step of determining if the building owner has applicable insurance that would cover the cause of the roof leak.

5. The process of claim 4, including the step of repairing the roof leak during the certification period at no cost to the building owner if it is determined that the cause of the leak is normal wear and tear not covered by insurance.

6. The process of claim 4, including the steps of preparing a cost estimate for emergency services, interior restoration and roof repair caused by the roof leak not covered by insurance and performing emergency services, interior restoration and roof repairs authorized by building owner.

7. The process of claim 4, including the step of determining if a claim is to be prepared and filed against the applicable insurance on behalf of the building owner or if the building owner is to pay for selected repair services.

8. The process of claim 7, including the step of voiding the certification if the building owner does not approve of the filing of a claim against the applicable insurance, and does not agree to pay for the selected repair services.

9. The process of claim 7, including the step of filing an insurance claim on behalf of the building owner for payment of losses covered by insurance.

10. The process of claim 9, including the step of assigning the insurance claim to a certification repair contractor and authorizing selected repair services.

11. The process of claim 10, including the steps of performing any necessary emergency services, interior restoration, and roof repairs caused by the roof leak covered by the insurance or authorized by the building owner.

12. The process of claim 4, including the step of determining that the cause of roof leak and damage is by a third party or other cause not covered by insurance.

13. The process of claim 12, including the step of determining if there is roof or interior damage resulting from the third party or non-covered cause.

14. The process of claim 13, including the step of assigning a claim against the third party to a roof certification contractor.

15. The process of claim 14, including the steps of preparing and filing a claim for losses against the third party and performing any authorized emergency services, interior restoration, and roof repair resulting from the third party damage.

16. The process of claim 13, including the steps of preparing a cost estimate for emergency services, interior restoration and roof repair resulting from the third party damage and performing emergency services, interior restoration and roof repairs authorized by building owner when a claim is not to be filed against the third party and the building owner agrees to pay for the repairs and services.
